(19) United States
(12) Patent Application Publication
(10) Pub. No.: US 2003/0229966 A1
(43) Pub. Date: Dec. 18, 2003

(54) Stroller height extenders and method

(76) Inventor: Angelia S. Boice, Bothell, WA (US)

Correspondence Address: LAW OFFICE OF POLLY L. OLIVER, P.O. BOX 4625, FEDERAL WAY, WA, 98063, US

(21) Appl. No.: 10/462,135

(22) Filed: Jun. 16, 2003

Related U.S. Application Data
(60) Provisional application No. 60/389,362, filed on Jun. 17, 2002.

(51) Int. Cl. B62B 9/20

(52) U.S. Cl. 16/110.1; 16/422; 16/436

(57) ABSTRACT

A height extender for attaching to the handle of a baby stroller is invented. The extender comprises a generally tubular and continuously curved bar, optionally covered with neoprene or some other gripping material, one end of which is removably and threadably fastened to the existing stroller handle by means of an adjustable clip. The clip assembly maintains the height extender roughly perpendicularly to the stroller handle (before the curve in the bar). The extender can be easily and quickly installed almost anywhere on the handle and can thereby be adjusted by the user to accommodate users of different sizes and gripping styles. Usually, two extenders are used—one for each hand.

### RELATED APPLICATION

This application claims priority under 35 U.S.C. 119(e) to U.S. provisional application Serial No. 60/389,362 filed on Jun. 17, 2002.

### FIELD OF THE INVENTION

This invention pertains generally to accessories for baby strollers and more specifically to height extenders for the stroller handles.

### BACKGROUND OF THE FIELD

Nearly all parents of young children use strollers for their babies and toddlers. Currently, there are many, many types of strollers being sold and used for such children. There are single-seat strollers for one child and tandem and side-by-side strollers for two children. There are strollers with added standing platforms for older children and strollers with built-in bags and compartments for storing baby accessories.

Although all kinds of parents use such strollers, most strollers are designed to be used by women 5′4″ or under. This leaves taller women and most men in the undesirable position of having to bend over or slump their shoulders to reach the handles and push the strollers. Such stooping and slumping not only is uncomfortable, but also can result in significant back, shoulder, and neck pain. Persistent poor posture and physical stress can then lead to more serious physical problems.

### SUMMARY OF THE INVENTION

The present invention solves the above-mentioned problems by providing an adjustable height extender for use by taller women and men so that they can stand up straight in a natural position while safely gripping the strollers' handles. At the same time, the invention also increases the horizontal distance between the pusher's body and the stroller so as to accommodate the taller pusher's greater stride. (The adjustable height extender can be used on any other device, such as luggage, with a handle that is too short for the pusher.)

The preferred embodiment of the present invention comprises a generally tubular bar, similar to a bicycle handle bar, one end of which is removably and adjustably attached to the stroller's existing handle using a clip assembly. The attachment is such that the bar extends generally perpendicularly from the handle, and the bar is usually bent so as to be at a comfortable angle for gripping with one hand. Further, the bar is normally covered with a soft gripping material such as neoprene. Although one height extender can be installed alone (at almost any point along the handle or the frame of the stroller), a pusher usually prefers to use two extenders as a pair, one for each hand.

In the preferred embodiment, a clip assembly is used to mount the extender bar onto the existing stroller handle. The clip assembly of the preferred embodiment comprises a clip element, a retainer element, and a tightening nut. Most strollers on the market today have tubular handles (and tubular frames), and so the clip assembly is designed to circumscribe a handle with a generally circular cross-section. Certainly clips could be designed for handles with different cross-sections, e.g., oval or square.

In the preferred embodiment, the clip assembly fits around the stroller's handle entirely circumscribing the handle. Then the extender bar threads onto the clip assembly, and the pusher finger-tightens the tightening nut. No tools are necessary for installing or removing the height extenders; no hardware needs to be permanently installed on the handle, and the clip assembly incorporates a special gripping material in its recesses so that it leaves no permanent marks on the handle.

### BRIEF DESCRIPTION OF THE DRAWINGS

FIG. 1 is a perspective view of the height extenders as they are used in the preferred embodiment;

FIG. 2 is an exploded side view of the clip assembly of the preferred embodiment; and

FIG. 3 is a top view of the retainer element.

### DETAILED DESCRIPTION OF THE PREFERRED EMBODIMENT

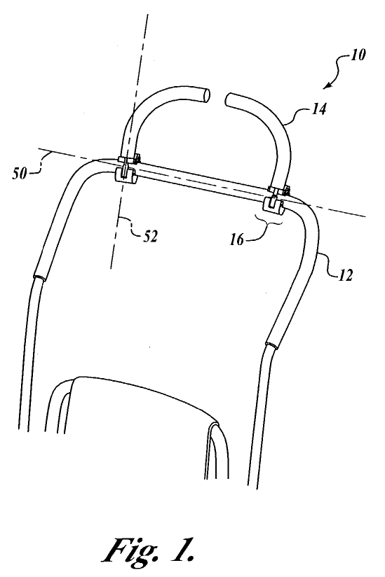

FIG. 1 shows a pair of height extenders 10 as they are typically installed on a stroller handlebar 12. As can be readily seen, each extender 10 of the typical pair is a mirror image of the other, so this discussion will focus on only one extender 10. It is understood that a single extender may be used alone and also that the extender(s) can be attached anywhere on the frame of the stroller (not shown), including the handle or handlebar 12. The extender comprises a bar 14 and a clip assembly 16, both of which are shown in greater detail in the following figures.

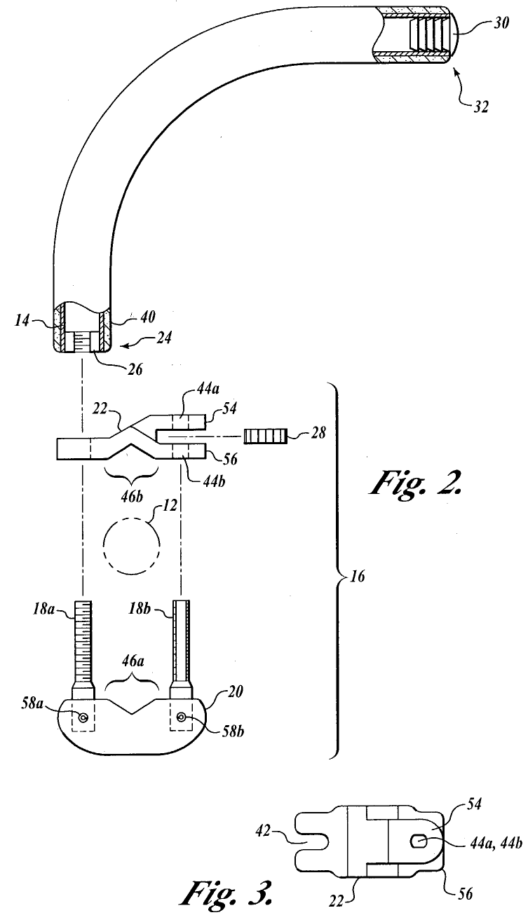

The stroller handlebar defines the axis 50, which is coincident with the bore axis 50 of the clip assembly 16. The proximate end 24 of the bar 14 defines the bar axis 52 which upon assembly is roughly perpendicular to the bore axis 50. (The bar is bent along its length so that the distal end 32 is displaced from the bar axis 52.) The bar 14 is generally tubular and can be of any length or bent into any shape, but for the preferred embodiment, it is gradually and continuously bent so as to be at a comfortable angle for a user to grip with one hand while standing behind the stroller. In the preferred embodiment, the bar is bent continuously as shown in FIG. 2, so that the overall bend is approximately 90 degrees. The extender 10 works well if the angle of bend measures within the range of 40 to 90 degrees.

FIG. 2 shows the bar 14 in side view showing how the bar 14 is bent and also that the bar screw 18a of the clip assembly 16 is generally coaxial with the proximate end 24 of the bar 14. It also shows how the bar 14 of the preferred embodiment is covered with a neoprene cover 40 so as to add softness and texture to the user's grip. In alternate embodiments, any appropriate material may be used, or optionally no cover at all.

Still referring to FIG. 2, the first screw (bar screw) 18a and the second screw (tightening screw) 18b of the clip element 20 extend from the clip body 20 through holes or slots (not threaded) in the retainer element 22, which in the preferred embodiment is generally rectangular (as can be seen in the top view of FIG. 3). The bar screw 18a of the preferred embodiment is pivotally fixed to the clip 20 (pivoting on pin 58a) but extends loosely through the slot 42 in the first end of the retainer 22 and is threaded up into the proximate end 24 of the normally hollow bar 14. If necessary, a threaded nut 26 may be spot-welded or otherwise retained inside the proximate end 24 of the bar 14 for receiving the screw 18a. In alternate embodiments, the bar 14 may be designed with an endplate defining a threaded screw receptacle.

The tightening screw 18b also is pivotally fixed to the clip 20 (pivoting on pin 58b) and extends loosely through holes 44a and 44b (not threaded) in the second end of the retainer element 22. A tightening nut 28 is threaded onto the screw 18b as it passes through the retainer, i.e., between holes 44a and 44b, and is used to tighten the clip assembly 16 around the stroller handlebar 12, by adjusting the size of the throughbore. In order to capture the nut 28 within the clip assembly 16, the retainer 22 of the preferred embodiment has two prongs 54 and 56 on the second end and defining the holes 44a and 44b respectively. The tightening nut 28 is finger-operated so that no tools are needed to install the height extenders 10.

The clip 20 and the retainer 22 of the clip assembly 16 are designed to define a throughbore that fits around and circumscribes the stroller handlebar 12 and defines the bore axis 50. In the preferred embodiment, the fit is accomplished with two mating recesses on the mating surfaces of the two elements, 46a in the clip 20 and 46b in the retainer 22, which are capable of defining the throughbore and seating the handlebar 12. Upon tightening of the nut 28, the size of the throughbore is adjusted so that the clip assembly 16 firmly holds the extender 10 on the handlebar 12 such that the bar axis 52 is roughly perpendicular to the bore axis 50. In the embodiment shown, the recesses 46a, 46b are roughly triangular, but in alternate embodiments, they could be of any other appropriate shape, such as semicircular to create a generally circular throughbore. Furthermore, the recesses 46a and 46b can be coated or otherwise covered with a gripping material which not only helps to grip the handlebar 12 but also prevents marks on the handlebar.

In the preferred embodiment, a cap 30 is mounted at the distal end 32 of the tubular bar 14. Obviously, in alternate embodiments, the cap 30 could be provided as an integral part to the bar 14.

FIG. 3 is a top view of the retainer element 22 showing the arrangement of slot 42 and holes 44a, 44b at either end of the element (the first and second ends respectively). The clip assembly, and therefore the entire invention, would work if the slot 42 were a hole in the retainer and the screws were fixed to the clip body (i.e., not pivoted); however a slot is chosen and the screws pivot in order to make installation easier.

What is claimed is:

1. A height extender, for attaching to the handle of a baby stroller, comprising:
a generally tubular bar having a threaded proximate end and a distal end, said proximate end defining a bar axis, said bar also being gradually and continuously bent along its length, defining an angle of bend, so that said distal end is displaced from said bar axis;
a clip assembly defining an adjustable throughbore having a bore axis therethrough and being removably and threadably attached to the proximate end of the bar such that the bore axis is roughly perpendicular to the bar axis, said throughbore being generally capable of circumscribing the handle of the baby stroller; and
means for adjusting the tightness of the clip assembly, around the handle of the baby stroller, by adjusting the size of the throughbore.

2. The height extender of claim 1 wherein the bar further comprises a cap mounted to the distal end of the bar.

3. The height extender of claim 1 wherein the angle of bend in the bar measures approximately 90 degrees from the proximate end to the distal end.

4. The height extender of claim 1 wherein the angle of bend in the bar measures within the range of 40 to 90 degrees from the proximate end to the distal end.

5. The height extender of claim 1 wherein the bar further comprises a neoprene cover mounted on the generally cylindrical bar.

6. The height extender of claim 1 wherein the clip assembly comprises a clip with a first screw threadably attached to the proximate end of the bar and a retainer removably linked to the clip, said clip and said retainer each defining a recess, and said recesses being capable of mating to form said throughbore.

7. The height extender of claim 1 wherein the clip assembly comprises a clip with a first screw threadably attached to the proximate end of the bar and a retainer removably linked to the clip, said clip having a mating surface defining a recess thereon and said retainer having a mating surface defining a recess thereon, such that the recesses form said throughbore upon mating.

8. The height extender of claim 1 wherein the clip assembly comprises a clip with a first screw threadably attached to the proximate end of the bar, said clip having a mating surface defining a clip recess thereon and said retainer having a mating surface defining a retainer recess thereon and being removably and adjustably linked to the clip such that the mating surfaces are adjacent each other and the recesses form said throughbore.

9. The height extender of claim 8 wherein the retainer element is generally rectangular in shape having a first end and a second end, the first end defining a slot and the second end defining at least one hole and the retainer recess being between the first and second ends, and the clip element further comprising a second threaded screw the clip recess being between the first and second screws, said first and second screws being designed to extend through the corresponding slot and holes of the retainer when the mating surfaces are mated.

10. The height extender of claim 1 wherein the adjusting means comprises a screw linked to the clip, said screw extending along an axis generally parallel to the bar axis, and a nut threaded onto said screw proximate the retainer.

11. The height extender of claim 10 wherein the retainer further defines two prongs, each prong defining an unthreaded hole therein, and the screw of the adjusting means extending through said holes, and the nut of the adjusting means being threaded onto the screw and being held between the two prongs of the retainer.

12. A height extender comprising:
a clip having a body, a first screw, and a second screw, the first and second screws being generally parallel to one another and being pivotally linked to the body of the clip,
a retainer defining a plurality of slots and holes, said retainer being adjustably linked through said slots and holes to the first and second screws of the clip,
a generally tubular bar having a threaded proximate end and a capped distal end, said bar being threadably linked at the proximate end to the first screw of the clip and said proximate end defining a bar axis, and
a nut threaded onto the second screw of the clip so as to be proximate the retainer.

12. The height extender of claim 11 wherein the bar is bent along its length such that the distal is displaced from the bar axis.

13. The height extender of claim 11 wherein the bar is bent gradually and continuously along its length from the proximate end to the distal end such that the overall bend angle is approximately 90 degrees.

14. The height extender of claim 11 wherein the clip defines a mating surface, the first and second screws extend roughly perpendicularly from said mating surface, and said mating surface further defines a generally triangular recess between the first and second screws.

15. The height extender of claim 14 wherein the retainer is of a generally rectangular shape having a first end and a second end, the first end defining a slot and the second end defining two holes, said holes being aligned with each other.

16. The height extender of claim 15 wherein the retainer further defines a mating surface, said mating surface further defining a generally triangular recess between the first and second ends.

17. The height extender of claim 11 wherein the bar further comprises a neoprene cover.

18. A method for extending the height of a baby stroller handle using a height extender comprising a bent bar having a threaded proximate end and a distal end and a clip assembly threadably attached to the proximate end of the bar, said clip assembly comprising a clip element having a body, a bar screw and a tightening screw pivotally linked to the body so as to extend roughly perpendicularly thereto, such body also defining a recess between the screws, and a retainer element having a plurality of slots and holes and also defining a recess, and a nut threaded onto the tightening screw, comprising the steps of:
fitting the clip element around the handle so that the recess of the clip element is seated around the handle and the screws of the clip element straddle and extend beyond the handle;
contemporaneously mounting the retainer element and the nut onto the tightening screw of the clip element so that the nut is trapped proximate the retainer element;
pivoting the tightening screw and thereby fitting the retainer element around the handle so that the recess of the retainer element is seated around the handle and the bar screw of the clip element extends through the corresponding slot of the retainer element; and
tightening the clip assembly around the handle by finger-tightening the nut on the tightening screw of the clip element.

19. The method of claim 18 further comprising the step of mounting and adjusting the bar by threading the proximate end thereof onto the bar screw of the clip element until the distal end of the bar is in the desired orientation.

20. The method of claim 18 wherein a second height extender is similarly mounted to the stroller handle so that the two height extenders are used in concert with each other.
